(19) United States
(12) Patent Application Publication
(10) Pub. No.: US 2010/0266179 A1
(43) Pub. Date: Oct. 21, 2010

(54) SYSTEM AND METHOD FOR TEXTURE VISUALIZATION AND IMAGE ANALYSIS TO DIFFERENTIATE BETWEEN MALIGNANT AND BENIGN LESIONS

(76) Inventors: Thomas E. Ramsay, Leesburg, VA (US); Eugene B. Ramsay, Tucson, AZ (US); Victor Krivorotov, Reston, VA (US); Gerard Felteau, Homestead, FL (US); Oleksandr Andrushchenko, Herndon, VA (US)

Correspondence Address: Rene A. Vazquez, 127 South Main Street, Marlborough, CT, 06447, US

(21) Appl. No.: 12/626,816

(22) Filed: Nov. 27, 2009

Related U.S. Application Data
(63) Continuation-in-part of application No. 11/374,612, filed on Mar. 14, 2006.
Application No. 11/374,612 is a continuation-in-part of application No. 11/136,406, filed on May 25, 2005, now Pat. No. 7,496,218.
Application No. 11/136,406 is a continuation-in-part of application No. 11/136,526, filed on May 25, 2005, now Pat. No. 7,492,937.
(60) Provisional application No. 61/118,027, filed on Nov. 26, 2008.

(51) Int. Cl. G06K 9/00

(52) U.S. Cl. 382/131

(57) ABSTRACT

A system and method for the analysis and visualization of normal and abnormal tissues, objects and structures in digital images generated by medical image sources is provided. The present invention utilizes principles of Iterative Transformational Divergence in which objects in images, when subjected to special transformations, will exhibit radically different responses based on the physical, chemical, or numerical properties of the object or its representation (such as images), combined with machine learning capabilities. Using the system and methods of the present invention, certain objects, such as cancerous growths, that appear indistinguishable from other objects to the eye or computer recognition systems, or are otherwise almost identical, generate radically different and statistically significant differences in the image describers (metrics) that can be easily measured.

### REFERENCE TO RELATED APPLICATIONS

This application is a continuation-in-part of U.S. patent application Ser. No. 11/374,612, filed on Mar. 14, 2006, which is a continuation-in-part of U.S. patent application Ser. No. 11/136,406, filed May 25, 2005 (now U.S. Pat. No. 7,496,218) and U.S. patent application Ser. No. 11/136,526, filed May 25, 2005 (now U.S. Pat. No. 7,492,937). This application also claims priority to U.S. Provisional Patent Application No. 61/118,027, filed Nov. 26, 2008. All of the above-identified applications are incorporated herein by reference in their entirety.

### BACKGROUND OF THE INVENTION

1. Field of the Invention

This invention relates to image analysis and, more specifically, to a system and method for the analysis and visualization of normal and abnormal tissues, objects and structures in digital images generated by medical image sources.

2. Background of the Related Art

Breast cancer is the most common cancer in women. Early detection of the cancer leads to significant improvements in conservative treatment. In recent years, mammography, ultrasound and MRI have proved invaluable in the management of breast cancer and the use of mammograms has resulted in national screening programs for all women in high risk groups. This, in turn, has lead to a large increase in the number of asymptomatic mammograms being presented, the majority of which are normal and resulted in unnecessary biopsies.

Similar issues confront accurate diagnosis of a sub-dermal hematoma in computer tomography (CT) scans and distinguishing tuberculosis bacilli from debris in digital images taken of stained sputum slides through a microscope. Numerous automated methods have been developed and employed to improve diagnostic performance to address this problem. Advances have been made to locate suspicious areas (ROI—Region of interest) but the outcome has been inadequate, specifically in small, subtle, dense lesions and infrequent abnormalities.

Some of the methods employed in previous methods are: (1) direct pixel/data histogram analysis of the whole image and/or ROI; (2) normalization of pixel intensity (remapping the pixels to a full 0-255 grey scale); (3) histogram equalization; (4) morphology analysis; (5) intensity-based statistics; (6) contour mapping; (7) generation of textural, feature-based models of ultrasound; (8) uptake and outwash of contrast in MRI studies of the breast; and (9) and texture analysis.

Analysis of mammograms, ultrasound, and MRI breast images encompasses the normal range of imaging modalities used for the detection of breast cancer. Each of these modalities can be used to determine possible indicators of malignancy in breast tissue. Because of the similarity of cancerous lesions to benign and normal tissue in these images, existing image analysis methodologies suffer from very high rates of false positives in order to assure a high level of sensitivity to the detection of the disease.

Existing image analysis approaches typically apply algorithms to the original pixel values of an image to determine the presence of abnormal masses. They then compare the results of processing with known morphological templates. This template matching process however relies on the probability that cancers will always conform to certain shapes, textures, or other measurable features. Unfortunately, this is not the case. Consequently, many approaches to finding cancerous lesions and distinguishing them from benign lesions have focused only on locating and counting microcalcifications and avoid detecting masses in the breast. Dense breast tissue provides an even greater challenge to the image analysis task. It is common to have 5,000 false positive areas in mammograms identified by a computer aided detection process for every cancerous mass detected.

Comparing results from multiple modalities adds further complexity to the image analysis process, since it may be difficult to compare the exact location of a mass using ultrasound with its position in two different views in a mammogram or with a sequence of images created by an MRI device.

Texture analysis is an often used method for determining tissue characteristics in medical images. The texture of a region describes the pattern of spatial variation of grey tones in a neighborhood that is small compared to the region. If the intensity values of an image are thought of as elevations, then texture is a measure of surface roughness.

A large body of literature exists for texture analysis of medical images such as ultrasound, magnetic resonance imaging (MRI), computer tomography (CT), fluorescence microscopy, light microscopy, and other digital images. Texture analysis techniques can be classified into three groups: (1) statistical technologies—based on region histograms and their moments (measurement of features such as coarseness and contrast); (2) spectral technologies: based on the autocorrelation function or power spectrum of a region (detection of texture periodicity, orientation, etc.); and (3) structural technologies—based on pattern primitives, (placement rules are used to describe the texture).

Many image analysis processes attempt to model areas of reduced texture energy (smoothness) rather than focusing on parameters that are dependent on original image intensity. There are several methods of textural feature extraction described in the literature, including the Laws Method. This method can yield secondary, strengthened features, which can then be used to segment or classify the image according to the texture energy.

Most reported work on texture is on feature analysis of whole images. For images of non-homogeneous textures, such as mammograms, an additional step of segmentation or classification is required. In the process, the Laws Method applied specific filter masks to the data to extract features and then used a statistical classification method to evaluate the significance of the features according to some pre-defined criteria. The Laws Method can be used to detect dots, lines and edges. In mammography, it has previously been used to discriminate between glandular and fatty regions of breast tissue, as part of an overall strategy to automatically detect breast asymmetries. These processes using intensity thresholding are unreliable due to between-image and within-image intensity variations.

FIG. 1 is a flow chart of a known image processing method, in which the Laws Method is used.

The process begins at step 10, where an original digital image is input into a computing system for analysis. Then, at step 12, the contrast of the image is adjusted using the image's histogram or the tonal distribution in a digital image. This step is often used to expand the differences between two similar tonal values in the image. At step 14, using Law's filters, texture analysis filters the original scalar image with a small convolution mask that enhances image spots, edges, or high-frequency components. The masks are frequently 3×3 pixels in size.

At step 16, mean smoothing is applied in order to reduce noise and/or to prepare images for segmentation. Filters such as median, Gaussian, pyramidal, and cone filters are examples of such filtering. Then, at step 18, thresholding is used to remove foreground objects from their background. Luminance values below or above a certain value may be removed. At step 20, morphology measurements may be made if the isolated regions of interest can be mapped against a template of known shapes.

Next, at step 22, contour mapping is employed when definite edges can be determined and isolated that define the outside boundaries of areas of interest. At step 24, segmented image masks isolate and often remap the pixels from the regions of interest that were isolated in step 20. Then, at steps 24 and 26, the pixels that form only the boundary of a region of interest are mapped so they can be used for feature extraction and classification.

At step 28, the pixels of the original image are compared mathematically with the segmented regions of interest. Finally, at step 30, the output image comprises the pixels of the segmented regions of interest.

### SUMMARY OF THE INVENTION

An object of the invention is to solve at least the above problems and/or disadvantages and to provide at least the advantages described hereinafter.

Therefore, an object of the present invention is to provide a system capable of detecting medical objects of interest in image data with a high degree of confidence and accuracy.

Another object of the present invention is to provide a system and method that does not directly rely on predetermined knowledge of an objects shape, volume, texture or density to be able to locate and identify a specific object or object type in an image.

Another object of the present invention is to provide a system and method of identifying objects of interest in medical image data that is effective at analyzing images in both two- and three-dimensional representational space using either pixels or voxels.

Another object of the present invention is to provide a system and method of distinguishing a class of known objects from objects of similar color and texture whether or not they have been previously explicitly observed by the system.

Another object of the present invention is to provide a system and method of identifying objects of interest in medical image data that works with very difficult to distinguish/classify image object types, such as: (i) apparent random data; (ii) unstructured data; and (iii) different object types in original images.

Another object of the present invention is to provide a system and method of identifying objects of interest in medical image data that can cause either convergence or divergence (clusterization) of explicit or implicit image object characteristics that can be useful in creating discriminating features/characteristics.

Another object of the present invention is to provide a system and method of identifying objects of interest in medical image data that can preserve object self-similarity during transformations.

Another object of the present invention is to provide a system and method of identifying objects of interest in medical image data that is stable and repeatable in its behavior.

To achieve the at least above objects, in whole or in part, there is provided a method of identifying a malignant region in a medical image, comprising receiving a medical image, applying at least one non-linear transformation to the medical image to segment and differentiate regions of interest, and determining whether a region of interest represents a malignant region or a benign region.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The patent or application file contains at least one drawing executed in color. Copies of this patent or patent application publication with color drawing(s) will be provided by the Patent Office upon request and payment of the necessary fee.

The invention will be described in detail with reference to the following drawings, in which like reference numerals refer to like elements, wherein:

FIG. 1 is a flowchart of a related art image processing method;

FIG. 2 is a bifurcation diagram;

FIG. 3A is an original x-ray image of a pipe containing explosives;

FIG. 3B is the image of FIG. 3A after application of the image transformation divergence process of the present invention;

FIG. 4 is a block diagram of a system for identifying an object of interest in image data, in accordance with one embodiment of the present invention;

FIGS. 5A-6C are transfer functions applied to the pixel color of the image, in accordance with the present invention;

FIG. 7A is an input x-ray image of a suitcase, in accordance with the present invention;

FIG. 7B is the x-ray image of FIG. 7a after application of the image transformation divergence process of the present invention;

FIG. 8 is a block diagram of an image transformation divergence system and method, in accordance with one embodiment of the present invention;

FIGS. 9A-9M are x-ray images of a suitcase at different stages in the image transformation recognition process of the present invention;

FIG. 9N is an example of a divergence transformation applied to an x-ray image during the image transformation divergence process of the present invention;

FIG. 10A is an original mammogram and an associated transform that outputs the original image unchanged;

FIG. 10B is a transform applied to the original image of FIG. 10A and the image output after application of the transform, in accordance with one embodiment of the present invention;

FIG. 11 is a transform applied to the image output after the transform of FIG. 10B, and the resulting image, in accordance with one embodiment of the present invention;

FIG. 12 is a transform applied to the image output after the transform of FIG. 11, and the resulting image, in accordance with one embodiment of the present invention;

FIGS. 13A and 13B are an original mammogram of a normal breast and the same mammogram after application of the image transformation divergence process of the present invention;

FIGS. 13C-13E are an original mammogram of a breast with a malignant growth and the same mammogram after application of the image transformation divergence process of the present invention.

FIGS. 14A-14C are an original mammogram of a dense breast with a benign growth and the same mammogram after application of the image transformation divergence process of the present invention;

FIGS. 14D-14F are an original mammogram of a dense breast with a malignant growth and the same mammogram after application of the image transformation divergence process of the present invention.

FIGS. 15A-15C are an original mammogram, taken with poor x-ray exposure, of a breast with a benign growth and the same mammogram after application of the image transformation divergence process of the present invention;

FIGS. 15D-15F are an original mammogram, taken with poor x-ray exposure, of a breast with a malignant growth and the same mammogram after application of the image transformation divergence process of the present invention.

FIGS. 16A-16C are an original mammogram of a breast with a subtle benign growth and the same mammogram after application of the image transformation divergence process of the present invention;

FIGS. 16D-16F are an original mammogram of a breast with a subtle malignant growth and the same mammogram after application of the image transformation divergence process of the present invention;

FIG. 17A is a mammogram of a breast with a malignant growth after application of the mammogram transformation divergence process of the present invention;

FIG. 17B is a mammogram of a normal breast after application of the mammogram transformation divergence process of the present invention;

FIG. 18 is a transform applied to an ultrasound image, in accordance with one embodiment of the present invention;

FIGS. 19A-19C are an original ultrasound image of a breast with a benign growth and the same image after application of the image transformation divergence process of the present invention;

FIGS. 19D-19F are an original ultrasound image of a breast with a malignant growth and the same image after application of the image transformation divergence process of the present invention;

FIGS. 20A-20C are an original ultrasound image of a breast with a benign growth and the same image after application of the image transformation divergence process of the present invention;

FIGS. 20D-20F are an original ultrasound image of a breast with a malignant growth and the same image after application of the image transformation divergence process of the present invention;

FIG. 21 is a vector representation that reflects the vertical and non-vertical directions of growth found in cancerous lesions;

FIG. 22 are mammograms with malignant and benign growths with the regions of interest having gone through the image transformation divergence process of the present invention, illustrating the number of unique colors present in the malignant and benign growths after the image transformation divergence process;

FIG. 23A are images comparing growth of cancer in a culture in a petri dish, cancer in an image taken from a biopsy under a microscope, and cancer in a mammogram, all of which have undergone the image transformation divergence process of the present invention;

FIG. 23B is a block diagram showing how ITD results from different imaging modalities can be combined and used to improve detection accuracy, in accordance with the present invention;

FIG. 24 is a flowchart of a method of creating a Support Vector Machine model, in accordance with one embodiment of the present invention;

FIG. 25 is a flowchart of a method of performing a Support Vector Machine operation, in accordance with one embodiment of the present invention; and

FIG. 26A is an x-ray image from a Smith Detection (Smith) x-ray baggage scanner.

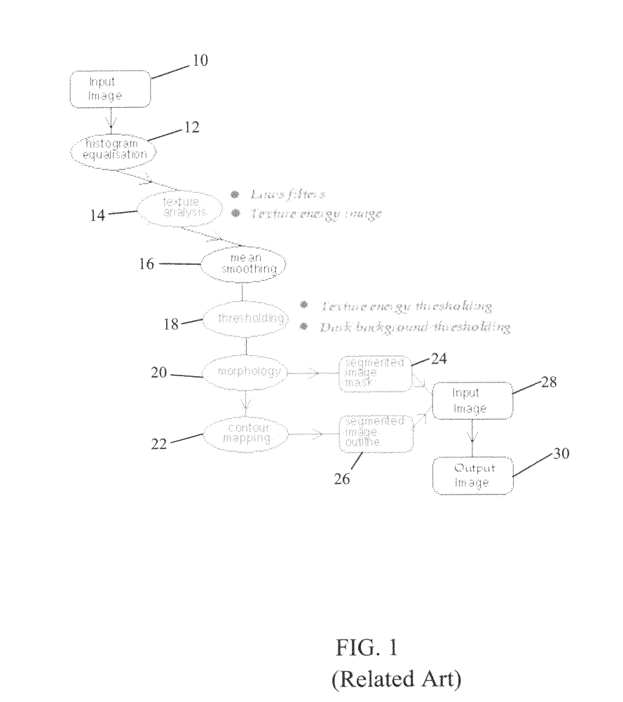

### DETAILED DESCRIPTION OF PREFERRED EMBODIMENTS

### Definition of Terms

The following definitions hold throughout the contents of this application. If additional or alternative definitions of the same or similar words are provided herein, those definitions should be included herein as well.

“Statistically identical” or “statistically indistinguishable”: Two sets of data are referred to as “statistically identical” or “statistically indistinguishable” if under one or more types of statistics or observation there is almost no discernible difference between them.

Point operation: Point operation is a mapping of a plurality of data from one space to another space which, for example, can be a point-to-point mapping from one coordinate system to a different coordinate system. Such data can be represented, for example, by coordinates such as (x, y) and mapped to different coordinates (α, β) values of pixels in an image.

Z effective (Z_{eff}): Is the effective atomic number for a mixture/compound of elements. It is an atomic number of a hypothetical uniform material of a single element with an attenuation coefficient equal to the coefficient of the mixture/compound. Z effective can be a fractional number and depends not only on the content of the mixture/compound, but also on the energy spectrum of the x-rays.

Divergence: The movement or spreading of points in vector space from within a local neighborhood (vicinity) to radically different values or locations.

“Divergence transform” or “bifurcation transform”: The phrases “divergence transform” and “bifurcation transform” are used interchangeably and each results from a nonlinear or discontinuous remapping of points in vector space which when operating on data such as an entire image, image segment, or subset of an image, causes information relating to the content of the data that otherwise would not have been readily or easily apparent to become available or more easily apparent or accessible.

“Divergence transformation” or “bifurcation transformation”: The phrases “divergence transformation” and “bifurcation transformation” are used interchangeably and refer to a transform which, when operating on data such as a segment or subset of an image, causes information relating to the content of the data that otherwise would not have been readily or easily apparent to become available or more easily apparent or accessible. The intent of the transform is to cause a bifurcation of the image data.

For example, when applying a divergence transformation to an image or a segment of the image, information regarding the contents of the image which would not have been easily recognized prior to application of the divergence transformation becomes more apparent or known. For example, two objects in the same image that are almost indistinguishable become distinguishable after the divergence transformation is applied.

Hyperspectral data: Hyperspectral data is data that is obtained from a plurality of sensors at a plurality of wavelengths or energies. A single pixel or hyperspectral datum can have hundreds or more values, one for each energy or wavelength. Hyperspectral data can include one pixel, a plurality of pixels, or a segment of an image of pixels, etc., with said content. As contained herein, it should be noted that hyperspectral data can be treated in a manner analogous to the manner in which data resulting from a divergence transformation is treated throughout this application for systems and methods for threat or object recognition, identification, image normalization and all other processes and systems discussed herein.

For example, a divergence transformation can be applied to hyperspectral data in order to extract information from the hyperspectral data that would not otherwise have been apparent. Divergence transformations can be applied to a plurality of pixels at a single wavelength of hyperspectral data or multiple wavelengths of one or more pixels of hyperspectral data in order to observe information that would otherwise not-have been apparent.

Nodal point: A nodal point is a point in an image transformation or series of image transformations where similar pixel values exhibit a significantly distinguishable change in value. Pixels are a unitary value within a 2D or multi-dimensional space (such as a voxel).

Object: An object can be a person, place or thing.

Object of interest: An object of interest is a class or type of object such as explosives, guns, tumors, metals, knives, camouflage, etc. An object of interest can also be a region with a particular type of rocks, vegetation, etc.

Threat: A threat is a type of object of interest which typically but not necessarily could be dangerous.

Image receiver: An image receiver can include a process, a processor, software, firmware and/or hardware that receives image data.

Image mapping unit: An image mapping unit can be a processor, a process, software, firmware and/or hardware that maps image data to predetermined coordinate systems or spaces.

Comparing unit: A comparing unit can be hardware, firmware, software, a process and/or processor that can compare data to determine whether there is a difference in the data.

Color space: A color space is a space in which data can be arranged or mapped. One example is a space associated with red, green and blue (RGB). However, it can be associated with any number and types of colors or color representations in any number of dimensions.

HSI color space: A color space where data is arranged or mapped by Hue, Saturation and Intensity.

Predetermined color space: A predetermined color space is a space that is designed to represent data in a manner that is useful and that could, for example, cause information that may not have otherwise been apparent to present itself or become obtainable or more apparent.

RGB DNA: RGB DNA refers to a representation in a predetermined color space of most or all possible values of colors which can be produced from a given image source. Here, the values of colors again are not limited to visual colors but are representations of values, energies, etc., that can be produced by the image system.

Signature: A signature is a representation of an object of interest or a feature of interest in a predetermined space and a predetermined color space. This applies to both hyperspectral data and/or image data.

Template: A template is part or all of an RGB DNA and corresponds to an image source or that corresponds to a feature or object of interest for part or all of a mapping to a predetermined color space.

Algorithms: From time to time, transforms and/or divergence transformations are referred to herein as algorithms.

Algorithms and systems discussed throughout this application can be implemented using software, hardware, and firmware.

Modality: any of the various types of equipment or probes used to acquire images. Radiography, CT, ultrasound and magnetic resonance imaging are examples for modalities in this context.

The analysis capabilities of the present invention can apply to a multiplicity of input devices created from different electromagnetic and sound emanating sources such as ultraviolet, visual light, infra-red, gamma particles, alpha particles, etc.

### Image Transformation Divergence System and Method—General Overview

The present invention is based on and builds on the Signature Mapping and Image Transformation (IR) or, equivalently, Iterative Transformational Divergence (ITD) techniques described in U.S. Pat. No. 7,496,218, U.S. Pat. No. 7,492,937, and co-pending U.S. patent application Ser. No. 11/374,612, filed on Mar. 14, 2006, all of which are incorporated by reference herein. The terms ITR and ITD refer to the same process, and may be used interchangeably herein.

The ITD process can cause different yet almost identical objects in a single image to diverge in their measurable properties. An aspect of the present invention is the discovery that objects in images, when subjected to special transformations, will exhibit radically different responses based on the pixel values of the imaged objects. Using the system and methods of the present invention, certain objects that appear almost indistinguishable from other objects to the eye or computer recognition systems, or are otherwise identical, generate radically different and significant differences that can be measured.

Another aspect of the present invention is the discovery that objects in images can be driven to a point of non-linearity by certain transformation functions. The transformation functions can be applied singly or in a sequence, so that the behavior of the system progresses from one state through a series of changes to a point of rapid departure from stability called the “point of divergence.”

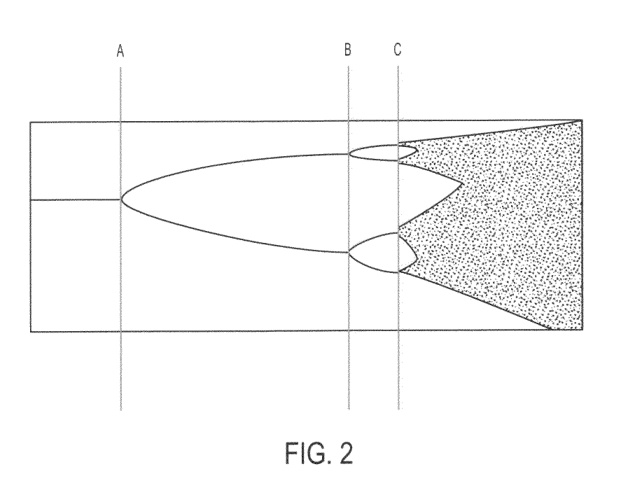

FIG. 2 is an example of a bifurcation diagram illustrating iterative uses of divergence transforms, where each node represents an iteration or application of another divergence transform. A single image is represented as a simple point on the left of the diagram. There are several branches in the diagram (at lines A, B and C) as the line progresses from the original image representation on the left, indicating node points where bifurcation occurs (“points of bifurcation”). In this example, three divergence transforms were used in series at points A, B and C. In this example, each divergence transform results in a bifurcation of the image objects or data. At point A, some objects that are very dissimilar from the objects of interest diverge away from the most likely object of interest candidates (e.g., threat vs. non-threat, malignant vs. benign tumor, vegetation vs. camouflage, etc.). This is defined mathematically as reaching a “Repeller Point.”

At point B, additional objects are rejected and diverge away from the remaining object of interest candidates. At point C, the search is further refined and additional objects are rejected and diverge away from the remaining object of interest candidates. This spatial filtering process is analogous to applying narrower and narrower band pass filters in the frequency domain.

At a certain number of iterations (beyond point C in this example), the object integrity may deteriorate or no further improvement in the detection process is realized. At this point, other methodologies, e.g., Machine Learning Algorithms (MLAs) may be applied to further distinguish the objects of interest from other object of interest candidates.

Another aspect of the present invention is that one can apply the “principle of divergence” to the apparent stability of fixed points or pixels in an image and, by altering one or more parameter values, give rise to a set of new, distinct and clearly divergent image objects. Because each original object captured in an image responds uniquely at its point of divergence, the methods of the present invention can be used in an image recognition system to distinguish and measure objects. It is particularly useful in separating and identifying objects that have almost identical color, density and volume.

The system and methods of the present invention provides at least the following advantages over prior image extraction methodologies:

(1) It is a system capable of detecting objects with a high degree of confidence;

(2) It does not rely only on a prior knowledge of an objects shape, volume, texture or density to be able to locate and identify a specific object or object type in the image;

(3) It is effective at analyzing images in multi-dimensional representational space using either pixels or voxels;

(4) It is most powerful where a class of known objects is to be distinguished from objects of similar color and texture, whether or not they have not been previously observed or trained by the ITD system;

(5) It works with very difficult to distinguish/classify image object types, such as different object types in original images (threats and non-threats for example or different types of threats) have almost indistinguishable differences between their features when analyzed;

(6) It can more effectively apply statistical analysis tools to distinguish data;

(7) It can cause either convergence or divergence of image object features;

(8) It can preserve object geometrical integrity during transformations; and

(9) It is stable and repeatable in its behavior.

In one exemplary embodiment of the present invention, special transformations are applied to images in an iterative “filter chain” sequence. The nature of the sequence of transforms causes objects in the image to exhibit radically different responses based on their pixel value(s) such as color (that are related to the physical properties inherent in the original objects in the image). Using the sequencing process, certain objects that appear almost indistinguishable to the eye or computer recognition systems from other objects, generate radically different and significant differences that can be easily measured.

As transform parameters are increased, the behavior of the objects progresses from one of simple stability, through a sequence of changes, to a state of a unique and radical change. The state of unique and radical change comes about due to a characteristic “signature” associated with the object of interest's interaction with the source used to create the image. These signatures are exploited by adapting the divergence transforms of the present invention.

The ITD process works with an apparently stable set of fixed points or pixels in an image and, by altering one or more parameter values, giving rise to a set of new, distinct, and clearly divergent image objects. Commonly used and understood transforms work within the domain where images maintain equilibrium. The general ITD algorithmic-approach provides for changes to be made in the transformations that are used, the sequence in which they are applied, and the number that are employed.

The ITD process generally incorporates one or more of the following steps as part of any image analysis and visualization application:

(1) Conversion of single channel (grayscale) values to multiple channels (color space)

(2) Normalization of the image values

(3) Segmentation to isolate objects/tissues/structures of interest (AOIs) from the original image

(4) Segregation process that causes objects/tissues of certain types to express unique image characteristics (signatures) that are quantifiably different from other object/tissue types

(Generally the Segregation process is applied to the AOIs generated in the segmentation process but may also be applied to any or all parts of the original image)

(5) Feature Extraction

(6) Feature Analysis

(7) Object Classification

As will be discussed in more detail below, the ITD method segments the image into objects of interest, then applies different filter sequences to the same original pixels in the identified objects of interest using the process. In this way, the process is not limited to a linear sequence of filter processing.

Because of the unique nature of the segmentation process using this iterative approach, objects within objects can be examined. As an example, an explosive inside of a metal container can be located by first locating all containers, remapping the original pixel data with known coordinates in the image and then examining the remapped original pixels in the identified object(s) in the image for threats with additional filter sequences.

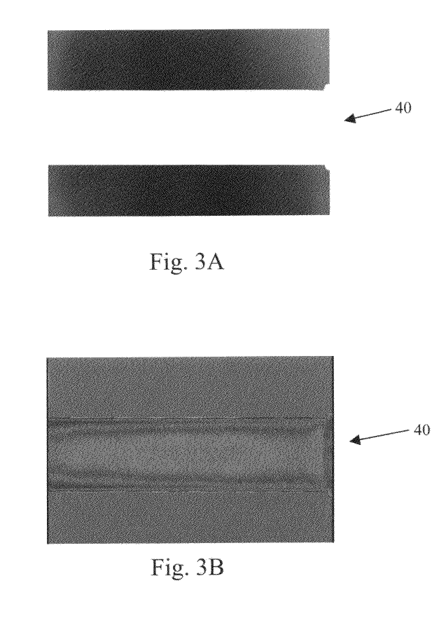

For example, FIG. 3A shows an x-ray image of a pipe containing explosive Pyrodex. The Pyrodex in the image appears visually to be all white. After converting the grayscale image to an RGB color space and applying an ITD algorithm to the original image, the texture of the explosive material inside the pipe is now visible, as shown in FIG. 3B, and has characteristics that can be effectively analyzed and classified by a processor.

In one embodiment of the ITD process, the pixel values in the original image that have the highest value (are very bright) are isolated through segmentation (in this case through thresholding) as an object of interest (AOI) and then an ITD algorithm is applied to the AOI to differentiate the pixels inside of the AOI in the segregation process. The combined color, texture, and pixel pattern signature in the processed image is unique for that combination of pipe and explosive material. It can be distinguished visually and mathematically from signatures of other materials in pipes.

With the ITD process, transforms can be tuned to optimize the distinction of the object of interest of the images. In addition, the process works for both image segmentation and feature generation through an iterative process of applying image transforms. As discussed above, it is defined mathematically as a reaching a Repeller Point.

The ITD methodologies of the present invention reveal signatures in radiographic image objects that have been previously invisible to the human eye. The application of specific non-linear functions to a grey-scale or color radiographic images is the basis of ITD. Due to the Compton and photoelectric effects, objects in the image exhibit unique, invariant responses to the ITD algorithms based on their physical interactions with the electromagnetic beam. By applying a combination of complementary functions in an iterative fashion, objects of very similar grey-scale or color content in the original image significantly diverge at a point of non-linearity. This divergence causes almost statistically equivalent objects in the original image to display significant density, color and pattern differences. Different algorithms are used for distinguishing objects that exhibit different ranges of effective atomic numbers (Z_{eff}). The algorithms are tuned to be optimal within certain fractional ranges of resultant electromagnetic Compton/photoelectric combinations.

Both spatial and spectral analysis is utilized. The probability of achieving accurate results can be improved by utilizing multiple passes. With each run of the ITD process, a new hyperplane of image pixel data is created for each object. The combination of the original image plus the newly-created hyperplanes is mapped to form a multi-spectral hypercube. The hypercube has pixel dimensions Pₙ where n is the total number of outputs from all iterations.

The hypercube now contains spectral bands for each object that are the result of the object's response to each ITD iteration. This is quite similar to the creation of hyperspectral data that is collected by sensors from the reflectance of objects. The hypercube data contains both spatial and spectral components that can be used for effective pattern classification rule generation.

Empirical testing has shown that objects retain their characteristic “response-based signatures” for a wide range of fractional Compton/photoelectric results, even when there is significant pixel mixing due to overlapping of other objects. This should not be completely unexpected since differences in a given object's thickness can generate the same Z_{eff} with the variability being expressed as a change in density.

### Exemplary Embodiments

A. General System and Method for Identifying an Object of Interest

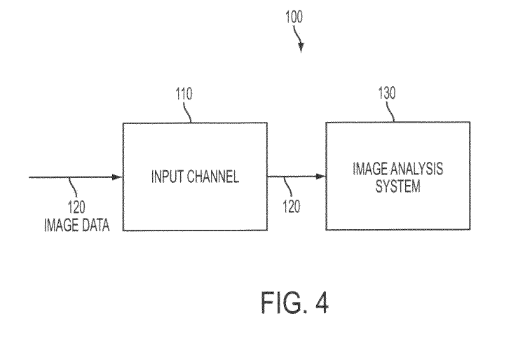

FIG. 4 is a block diagram of a system 100 for identifying an object of interest in image data, in accordance with one embodiment of the present invention. The system 100 comprises an input channel 110 for inputting image data 120 from an image source (not shown) and an image analysis system 130. In one preferred embodiment of the present invention, the image analysis system 130 generates transformed image data utilizing ITD, in which the object of interest is distinguishable from other objects in the image data.

The object of interest can be any type of object. For example, the object of interest can be a medical object of interest, in which case the image data can be computer tomography (CT) image data, x-ray image data, or any other type of medical image data. As another example, the object of interest can be a threat object, such as weapons, explosives, biological agents, etc., that may be hidden in luggage. In the case, the image data is typically x-ray image data from luggage screening machines.

At least one divergence transformation, preferably a point operation, is preferably utilized in the image analysis system 130. A point operation converts a single input image into a single output image. Each output pixel's value depends only on the value(s) of its corresponding pixel in the input image. Input pixel coordinates correlate to output pixel coordinates such that Xᵢ, Yᵢ→Xₒ, Yₒ. A point operation does not change the spatial relationships within an image. This is quite different from local operations where the value of neighboring pixels determines the value of the output pixel.

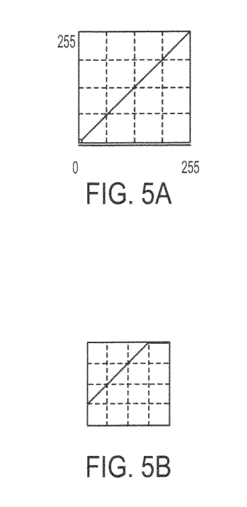

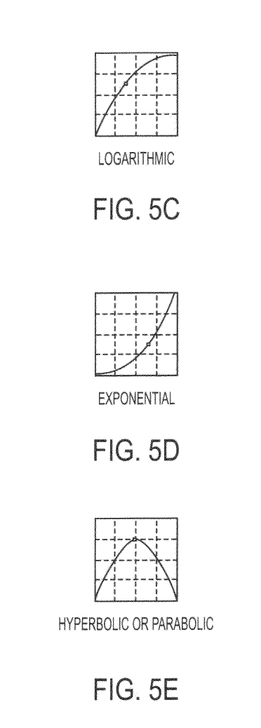

Point operations can correlate both gray levels and individual color channels in images. One example of a point operation is shown in the transfer function of FIG. 5A. In FIG. 5A, 8 bit (256 shades of gray) input levels are shown on the horizontal axis and output levels are shown on the vertical axis. If one were to apply the point operation of FIG. 5A to an input image, there would be a 1 to 1 correlation between the input and the output (transformed) image. Thus, input and output images would be the same.

Point operations are predictable in how they modify the histogram of an image. Point operations are typically used to optimize images by adjusting the contrast or brightness of an image. This process is known as contrast enhancing. They are typically used as a copying technique, except that the pixel values are modified according to the specified transfer function. Point operations are also typically used for photometric calibration, contrast enhancement, monitor display calibration, thresholding and clipping to limit the number of levels of gray in an image. The point operation is specified by the transformation function ƒ and can be defined as:

B(x, y)=ƒ[A(x, y)],

where A is an input image and B is an output image.

The at least one divergence transformation used in the image analysis system 130 can be either linear or non-linear point operations, or both. Non-linear point operations are used for changing the brightness/contrast of a particular part of an image relative to the rest of the image. This can allow the midpoints of an image to be brightened or darkened while maintaining blacks and white in the picture.

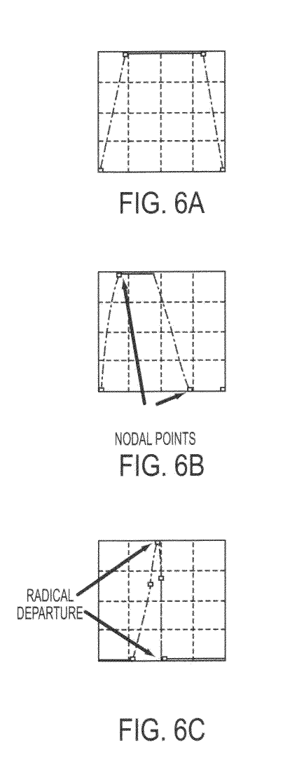

FIG. 5B is a linear transfer function, and FIGS. 5C-5E illustrate transformations of some non-linear point operations. An aspect of the present invention is the discovery that the transfer function can be used to bring an images to a point where two initially close colors become radically different after the application of the transfer function. This typically requires a radical change in the output slope of the resultant transfer function of FIG. 6A.

The present invention preferably utilizes radical luminance (grayscale), color channel or a combination of luminance and color channel transfer functions to achieve image object differentiation for purposes of image analysis and pattern recognition of objects. The placement of the nodal points in the transfer function(s) is one key parameter. An example of nodal point placements are shown in the transfer function example illustrated in the FIG. 6B. The nodal points in the transfer function used in the present invention are preferably placed so as to frequently create radical differences in color or luminance between image objects that otherwise are almost identical.

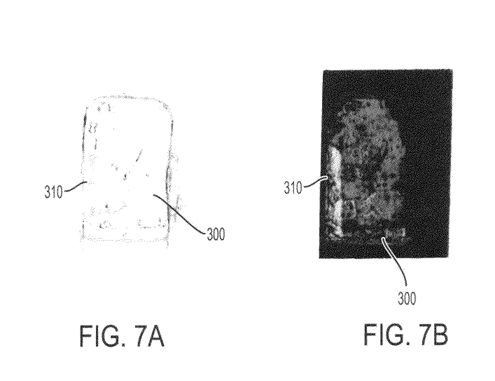

This is illustrated in the sample transfer function of FIG. 6C. Using this transformation, two objects that are very close in color/luminance in an original image would be on opposite sides of a grayscale representation in the output (transformed) image. FIG. 7A shows an input image, and FIG. 7B shows the changes made to the input image (the transformed image obtained) as a result of applying the transfer function of FIG. 6C. The input image is an x-ray image of a suitcase taken by a luggage scanner. In this example, the objects of interest are shoes 300 and a bar of explosives 310 on the left side of the suitcase.

Note that the orange background has gone a very different color from the shoes 300 and the bar 310 on the left side of the suitcase. The transfer function of FIG. 6C uniquely delineates the objects of interest, while eliminating the background clutter in the image.

As can be seen by the input and transformed images shown in FIGS. 7A and 7B, respectively, the orange background in the image makes a radical departure from the orange objects of interest (300 and 310) and other objects that are almost identical to the objects of interest. The use of different nodal points in the transfer function will cause the objects of interest to exhibit a different color from other objects.

Data points connecting the nodes can be calculated using several established methods. A common method of mathematically calculating the data points between nodes is through the use of cubic splines.

Additional imaging processes are preferably applied in the process of object recognition to accomplish specific tasks. Convolutions such as median and dilate algorithms cause neighboring pixels to behave in similar ways under the transfer function, and may be applied to assure the objects' integrity during the transformation process.

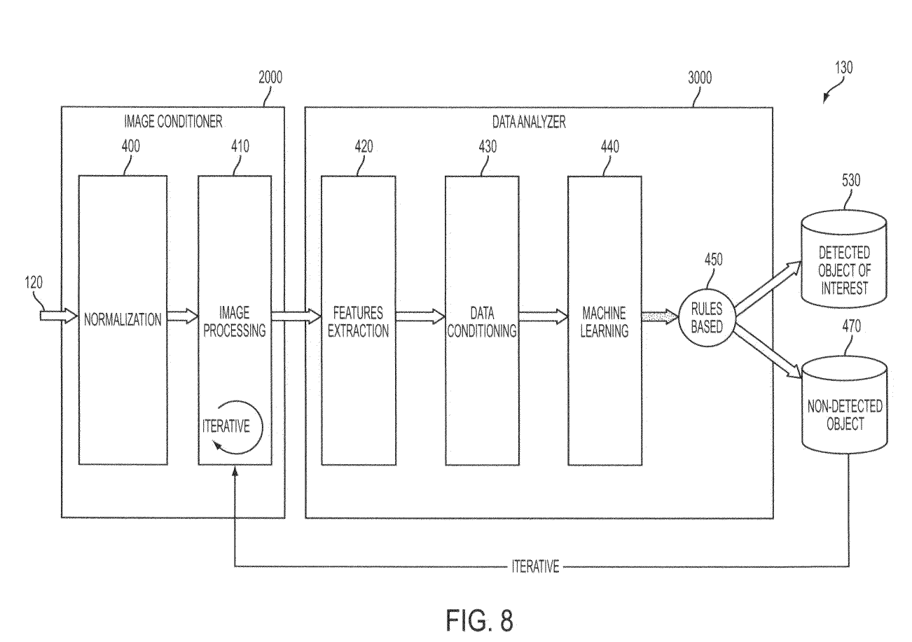

FIG. 8 is a block diagram of one preferred embodiment of the image analysis system 130 of FIG. 4, along with a flowchart of a method for identifying an object of interest in image data using the image analysis system 130. The image analysis system 130 includes an image conditioner 2000 and a data analyzer 3000.

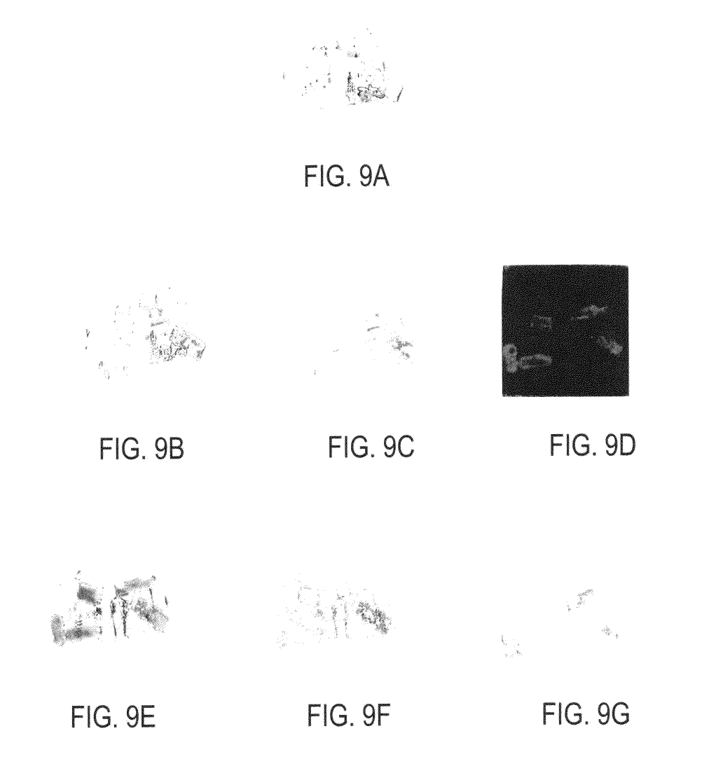

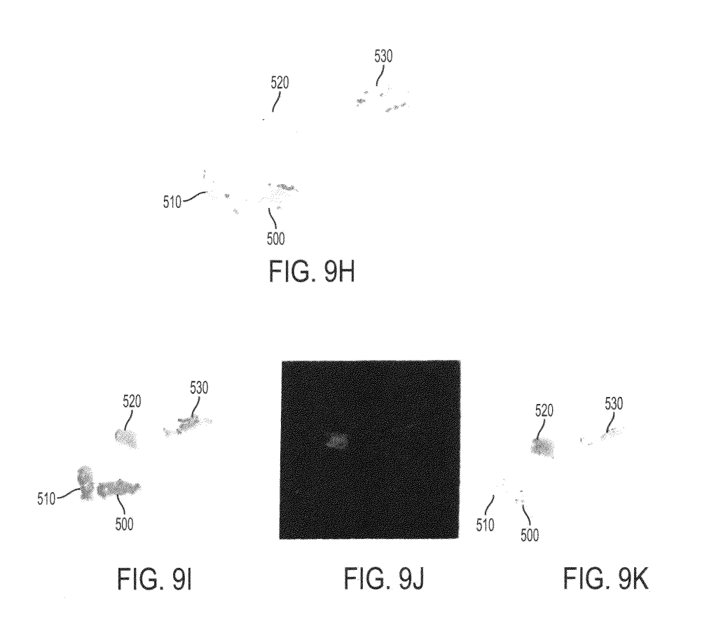

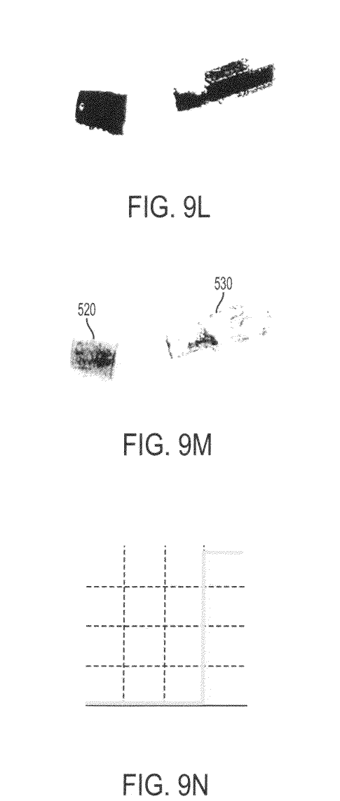

Some of the method steps will be explained with reference to the images shown in FIGS. 9A-9M, which are x-ray images of a suitcase at different stages in the image analysis process. These images are just one example of the types of images that can be analyzed with the present invention. Other types of images, e.g., medical images from X-ray machines or CT scanners, can also be analyzed with the system and methods of the present invention, as will discussed in more detail below.

The method starts at step 400, where image may optionally be normalized. The normalization process preferably comprises the following processes: (1) referencing; (2) benchmarking; (3) conformity process; and (4) correction process.

The referencing process is used to get a reference image containing an object of interest for a given type of X-ray machine. This process consists of passing a container containing one or more objects of interest into a reference X-ray machine to get a reference image. The referencing process is preferably performed once for each X-ray machine model/type/manufacturer.

The benchmarking process is used to get a transfer function used to adjust the colors of the reference image taken by a given X-ray machine that is not the reference X-ray machine. This process consists of passing a reference container into any given X-ray machine to get the image of this reference container, which is herein referred to as the “current image.” Then, the current image obtained for this X-ray machine is compared with the reference image. The difference between the current image and the reference container is made to create a transfer function.

As a transformation of the image's colors of a container, the benchmarking process determines the transfer function that maps all the colors of the current image color scheme (“current color scheme”) to the corresponding colors that are present in the reference color scheme of the reference image. The transfer function applied to the current image transforms it into the reference image.

The adjustment of the colors of X-ray machines of a different type/model/manufacturer requires a distinct and specific calibration process. All X-ray machines are preferably also put through a normalization process. X-ray machines of a same type/model/manufacturer are preferably normalized using the same calibration process. All X-ray machines of different types are preferably calibrated and all the machines, no matter their type, are preferably normalized.

The conformity process is preferably used to correct the image color representation of any objects that pass through a given X-ray machine. For a given X-ray machine, the conformity process corrects the machine's image color representation (color scheme) in such a way that the color scheme of a reference image will fit the reference color scheme of the reference container.

The conformity process preferably consists of applying the transfer function to each bag that passes into an X-ray machine to “normalize” the color output of the machine. This process is specific to every X-ray machine because of the machine's specific transfer function. Each time a container passes through the X-ray machine, the conformity process is preferably applied.

The correction process is preferably used to correct the images from the X-ray machine. It preferably minimizes image distortions and artifacts. X-ray machine manufacturers use detector topologies and algorithms that could have negative effects on the image geometry and colors. Geometric distortions, artifacts and color changes made by the manufacturer have negative impacts on images that are supposed to rigorously represent the physical aspects and nature of the objects that are passed through the machine.

Unlike the conformity process that preferably compensates in a specific way the randomness of the X-ray detector sensitivities of every X-ray machine, the correction process is preferably the same for all X-ray machines of a given model/type/manufacturer.

Next, at step 410, image processing is performed on the image. Many different types of image processing techniques can be used including, but not limited to, ITD, spatial and spectral transformations, convolutions, histogram equalization and gamma adjustments, color replacement, band-pass filtering, image sharpening and blurring, region growing, hyperspectral image processing, color space conversion, etc.

In one preferred embodiment, ITD is used for the image processing step 410, and as such the image is segmented by applying a color determining transform that effect specifically those objects that match a certain color/density/effective atomic number characteristics. Objects of interest are isolated and identified by their responses to the sequence of filters. Image segmentation is preferably performed using a series of sub-steps.

FIGS. 9B-9H show the image after each segmentation sub-step. The resulting areas of green in FIG. 9G are analyzed to see if they meet a minimum size requirement. This removes the small green pixels. The remaining objects of interest are then re-mapped to a new white background, resulting in the image of FIG. 9H. Most of the background, organic substances, and metal objects are eliminated in this step, leaving the water bottle 500, fruit 510, peanut butter 520 and object of interest 530.

At step 420, features are extracted by the data analyzer 3000 subjecting the original pixels of the areas of interest identified in step 410 to at least one feature extraction process. It is at this step that at least one divergence transformation is applied to the original pixels of the areas of interest identified in step 410.

In the image examples shown in FIGS. 9I-9M, two feature extraction processes are applied. The first process in this example uses the following formulation (in the order listed):

(1) Replace colors

(2) Maximum filter 3×3

(3) Median filter 3×3

(4) Levels and Gamma Luminance=66 black level and 255 white level and Green levels=189 black, 255 white and gamma=9.9

(5) Apply divergence transformation

(6) Maximum filter 3×3

(7) Replace black with white

(8) Median filter 3×3

The image shown in FIG. 9I results after process step (4) above, the image shown in FIG. 9J results after process step (5) above, and the image shown in FIG. 9K results after process step (7) above. Note that most of the fruit 510 and the water bottle 500 pixels on the lower left-hand side of the image in FIG. 9K have either disappeared or gone to a white color. This is in contrast to the preservation of large portions of the peanut butter jar 520 pixels and object of interest 530 pixels, which are now remapped to a new image in preparation for the second feature extraction process (FEP).

At step 430, data conditioning is performed by the data analyzer 3000, in which the data is mathematically transformed to enhance its efficiency for the MLA to be applied at step 440. In addition, meta data is created (new metrics from the metrics created in the feature extraction step 420 such as the generation of hypercubes. This metadata can consist of any feature that is derived from the initial features generated from the spatial domain. Meta data are frequently features of the spectral domain, Fourier space, RGB_DNA, and z-effective among others.

Machine Learning Algorithms (MLAs) are capable of automatic pattern classification. Pattern classification techniques automatically determine extremely complex and reliable relationships between the image characteristics also called features. These characteristics are use by the Rules-base that exploits the relationships to automatically detect object into the images.

At step 440, machine learning algorithms (MLAs) are applied by the data analyzer 3000. The, feature extraction process of step 420 is applied in order to represent the images with numbers. The MLAs applied at step 440 are responsible for generating the detection system that determines if an object of interest is present. In order to work properly, MLAs need structured data types, such as numbers and qualitative/categorical data as inputs. Since images are unstructured data types, the Feature Extraction Process is applied to transform the image or segments of an image into numbers. Each number is a metric that represents a characteristic of the image. Each image is associated with a collection of the metrics that represents it. The collection of the metrics related to an image is herein referred to as a vector. MLAs analyze the vector of the metrics for all the images and find the metrics' relationships that make up a “rules-base.”

The metrics created by the feature extraction process 420 are used to reflect the image content are, but not limited to, mean, median, standard deviation, rotation cosine measures, kurtosis, Skewness of colors and, spectral histogram, co-occurrence measures, gabor wavelet measures, unique color histograms, percent response, and arithmetic entropy measures.

At step 450, the objects are classified by the data analyzer 3000 based upon the rules-base that classify images into objects of interest and objects not of interest according to the values of their metrics, which were extracted at step 420. As shown in FIG. 9M, the object of interest 530 is measured in this process for its orange content. The peanut butter jar 520 shows green as its primary value, and is therefore rejected.

The detected objects of interest 530 are thus distinguished from all other objects (non-detected objects 470). Steps 410-450 may be repeated as many times as desired on the non-detected objects 470 in an iterative fashion in order to improve the detection performance.

Determination of distinguishing features between objects of interest and other possible objects is done by the rule-base as a result of the analysis of the vectors of the metrics by the MLAs applied at step 440. There are hundreds of different MLAs that can be used including, but not limited to, decision trees, neural networks, support vector machines (SVMs) and Regression.

The rules-base is therefore preferably entered into code and preferably accessed from an object oriented scripting language, such as Threat Assessment Language (TAL). A sample of TAL is shown below.

```
    call show_msg(“C4 Process 3a”)
    call set_gray_threshold(255)
    call set_area_threshold(400)
    call
color_replace_and(image_wrk,dont_care,dont_care,greater_than,0,0,45,255,255,255)
    call
color_replace_and(image_wrk,less_than,dont_care,less_than,128,0,15,255,255,255)
    call apply_curve(image_wrk,purple_path)
    call color_replace_and(image_wrk,equals,equals,equals,65,65,65,255,255,255)
    call color_replace_and(image_wrk,equals,equals,equals,0,255,0,255,255,255)
    call color_replace_and(image_wrk,greater_than,equals,equals,150,0,255,0,255,0)
    call color_replace_and(image_wrk,equals,equals,equals,0,0,255,255,255,255)
    call
color_replace_and(image_wrk,dont_care,less_than,less_than,0,255,255,255,255,255)
    call color_replace_and(image_wrk,dont_care,equals,dont_care,0,0,0,255,255,255)
    #if (show_EOP = 1)
    # call display_and_wait(image_wrk)
    #endif
    call pix_map = get_first_aoi(image_wrk,ALLCHAN,1,0)
    if (pix_map = 0)
      jump @done_with_file
    endif
    call destroy_pixmap(AOI_wrk)
    call AOI_wrk = copy_pixmap
    call color_replace(image_tmp,greater_than,greater_than,greater_than,−1,−1,−
1,255,255,255)
    aoinum = 1
    @C4loop3
      call show_AOI_bounding_box( )
    # if (show_AOI = 1)
    #  call display_and_wait(AOI_wrk)
    # endif
      call AOI_masked = get_pixmap_from_bbox(scan_org,0)
      call image_tmp2 = composite_aoi(image_tmp,AOI_masked,255,255,255)
      call destroy_pixmap(image_tmp)
      call image_tmp = copy_pixmap(image_tmp2)
      call destroy_pixmap(image_tmp2)
      call destroy_pixmap(AOI_masked)
      call pix_map = get_next_aoi( )
      if (pix_map = 0)
        call destroy_aoi_list( )
        jump @C4Process3b
        endif
      call destroy_pixmap(AOI_wrk)
      call AOI_wrk = copy_pixmap
      aoinum = aoinum + 1
    jump @C4loop3
```

A second pass is now made with all remaining objects in the image. The rules defined above can now eliminate objects identified in process 1. A second process that follows the logic rules will now create objects of new colors for the remaining objects of interest. The vectors of metrics of the transformed objects of interest are examined. Multiple qualitative approaches may be used in the evaluation of the objects, such as prototype performance and figure of merit. Metrics in the spatial domain, such as image amplitude (luminance, tri-stimulus value, spectral value) utilizing different degrees of freedom, the quantitative shape descriptions of a first-order histogram, such as standard deviation, mean, median, Skewness, Kurtosis, Energy and Entropy, % Color for red, green, and blue ratios between colors (total number of yellow pixels in the object/the total number of red pixels in the object), object symmetry, arithmetic encoder, wavelet transforms as well as other home made measurements are some, but not all, of the possible measurements that can be used. Additional metrics can be created by applying spectrally-based processes, such as Fourier, to the previously modified objects of interest or by analyzing eigenvalue produced from a Principal Components Analysis to reduce the dimension space of the vectors and remove outliers and non-representative data (metrics/images).

A color replacement technique is used to further emphasize tendencies of color changes. For example, objects that contain a value on the red channel>100, can be remapped to a level of 255 red so all bright red colors are made pure red. This is used to help identify metal objects that have varying densities.

This can now help indicate the presence of a certain metal objects regardless of its orientation in the image. It can also be correlated to geometric measurements using tools that determine boundaries and shapes. An example would be the correlation of the pixels with this red value with boundaries and centroid location. Other process may additionally be used as well.

The system and methods of the present invention are based on a methodology that is not restricted to a specific image type or imaging modality. It is capable of identifying and distinguishing a broad range of object types across a broad range of imaging applications. It works equally as well in applications such as CT scans, MRI, PET scans, mammography, cancer cell detection, geographic information systems, and remote sensing. It can identify and distinguish metal objects as well.

B. Medical Image Analysis

The following is one exemplary sequence of a Signature Mapping/ITD process as applied to a mammogram:

Convert the original grayscale x-ray image into a color space such as RGB;

Normalize the image;

Apply a series of non-linear transformations to segment and differentiate a cancerous from benign lesion;

Quantify the color values of the lesions;

Convert the image back into grayscale for display;

Quantify the luminance values of the lesions; and

Classify the objects;

The normalization process is applied, if necessary, by adjusting the black and white levels of the image. The normalization process may be applied to either areas of interest or to the entire image. This allows the algorithm to perform consistently across images of varying exposure and density.

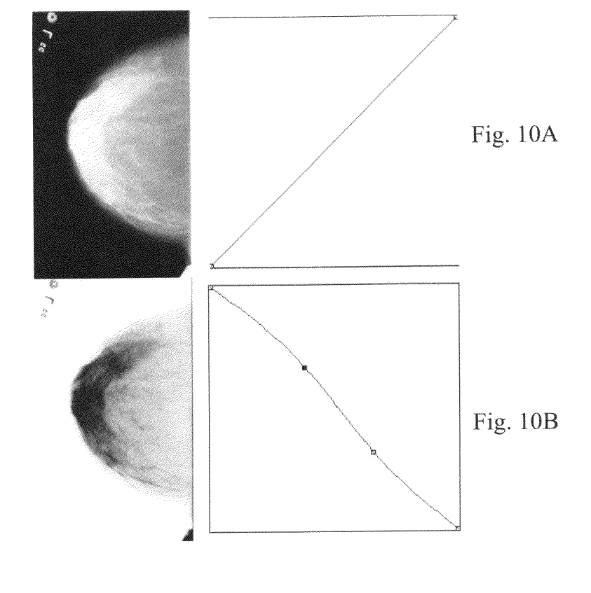

By way of example, three transforms can be applied sequentially to the image or objects segmented from the image. The transform, shown in FIG. 10B, provides a modified inverse to the values of the original image shown in FIG. 10A. The x values along the bottom are luminance input values, and the y axis represents luminance output values. The gray-colored shadow is a histogram or plot of the distribution of the pixel values before any transform is applied. In FIG. 10A, the diagonal black line indicates that all input values of luminance for each of the red (R), green (G), and blue (B) channels on the x axis will have the identical value for output on the y axis. All values for that image will remain unchanged. It is equivalent to not applying any transform to the image. The transform indicated in FIG. 10B shows that the image will essentially be inversed.

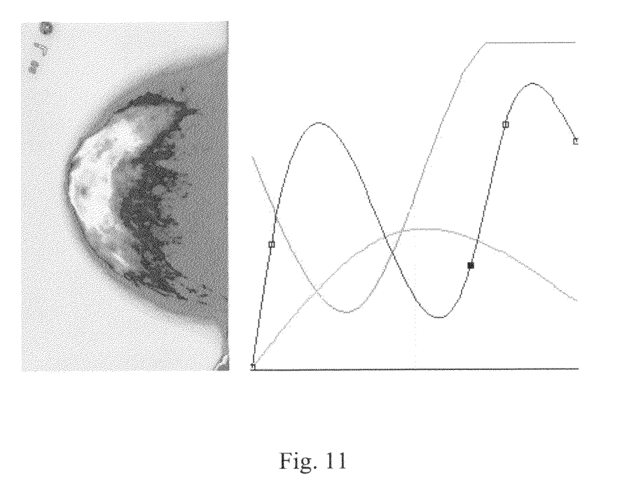

A second non-linear transform, shown in FIG. 11, remaps the resultant or output image from the previous step using the luminance, red and green channels. The x values along the bottom are luminance input values, and the y axis represents luminance output values. The input and output values can be for the combined luminance value or values for each of the color channels of RGB. In this transform, the blue channel is modified only by the change in luminance. The green and red channel pixel values are additionally modified by the changes indicated by the red and green curves.

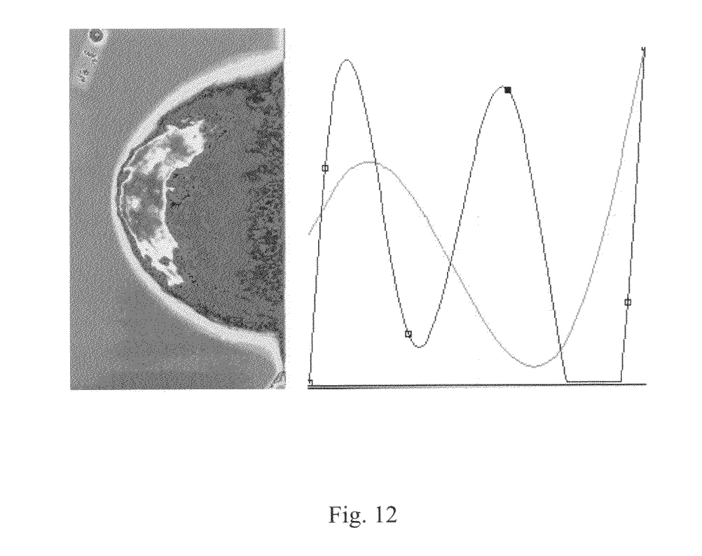

The final transform, shown in FIG. 12, remaps the values output from the transform of FIG. 11 using the luminance and red channels. The x values along the bottom are luminance input values, and the y axis represents luminance output values.

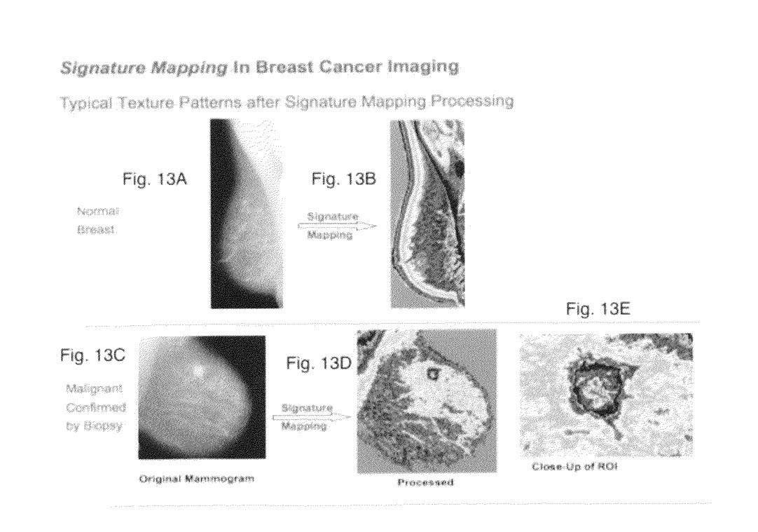

The results of the process described above can be seen in FIGS. 13A-13E. FIG. 13A shows the original mammogram of a normal breast. FIG. 13B shows the result of processing the original image with the process described above.

FIG. 13C is an original image that contains a cancerous lesion. FIG. 3D shows the result of processing the original image with the above process. FIG. 13E is a close up of the region of interest (ROI) where the tumor is located in the mammogram. A dark boundary can be observed in the close up image. This “signature” defines the characteristic boundary observed with cancerous lesions when processed with this algorithm.

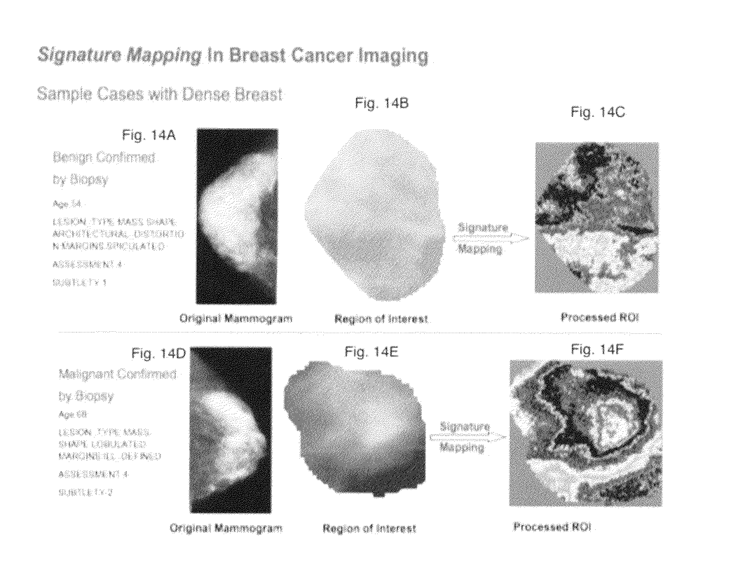

FIGS. 14A-14F show the results of the process using mammography images of a dense breast. FIG. 14A shows the original mammogram of a breast with a benign growth, with a close up of the ROI shown in FIG. 14B. FIG. 14C shows the result of processing the image with the process described above.

FIG. 14D shows the original mammogram of the dense breast with a malignant growth, with a close up of the ROI shown in FIG. 14E. FIG. 14F shows the result of processing the image with the process described above.

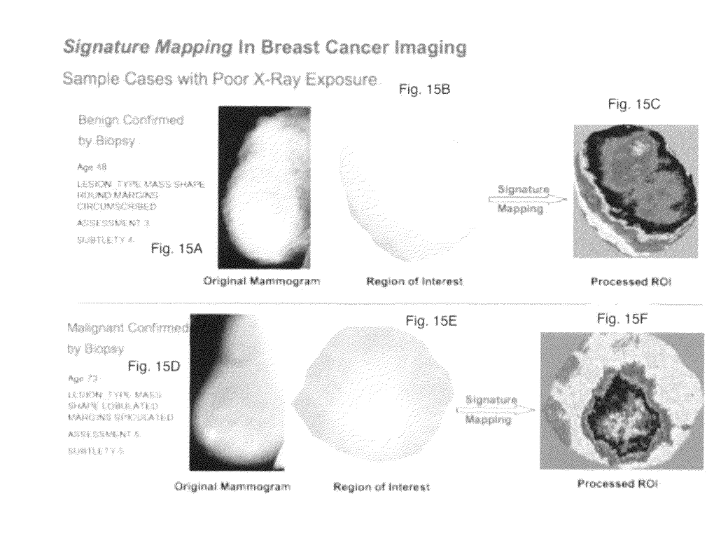

FIGS. 15A-15F show the results of the process using mammography images of a breast taken with poor x-ray exposure. FIGS. 15A-15C are with a benign growth, and FIGS. 15D-15F are with a malignant growth. FIGS. 15C and 15F show the result of processing each image with the process described above.

FIG. 15C shows that this benign mass also has a border; however the signature of the interior of the mass is significantly different from those of cancerous lesions. The visualized differences can be easily observed and quantified for classification purposes.

Each of the segments of the mammogram images can be further analyzed using feature extraction to develop rules for classifying the objects. Consequently, the process provides both a visualization tool for human interpretation and optimal tissue differentiation of topological features for both human interpretation and computer-based analysis.

The response-based Signature Mapping/ITD process helps to define the extent of the lesions and marks the boundaries of their growth. In addition to clustering the neighborhoods of pixels unique to the entire lesion, structures within the lesions itself are differentiated. This can be observed in FIGS. 15C and 15F. There is no formal structure observed within the benign lesion but the cancerous lesion in FIG. 15F indicates a highly organized pattern of different tissues within its boundaries. These highly structured patterns within the boundaries of lesions can be used to further define their direction of growth.

Measurements such as Co-occurrence—Energy, Entropy, Homogeneity and relative statistics such as Correlation and Standard Deviation are then used in the process to mathematically classify the objects of interest. For example, benign and cancerous lesions show significant differences in frequency information, boundaries, and color/grayscale gradients after being processed with Signature Mapping/ITD. After processing, masses in dense breast tissue that initially appeared to be uniform in texture can exhibit significant differences in entropy, linearity, and homogeneity than the surrounding dense breast tissue or benign masses in similarly dense breast tissue.

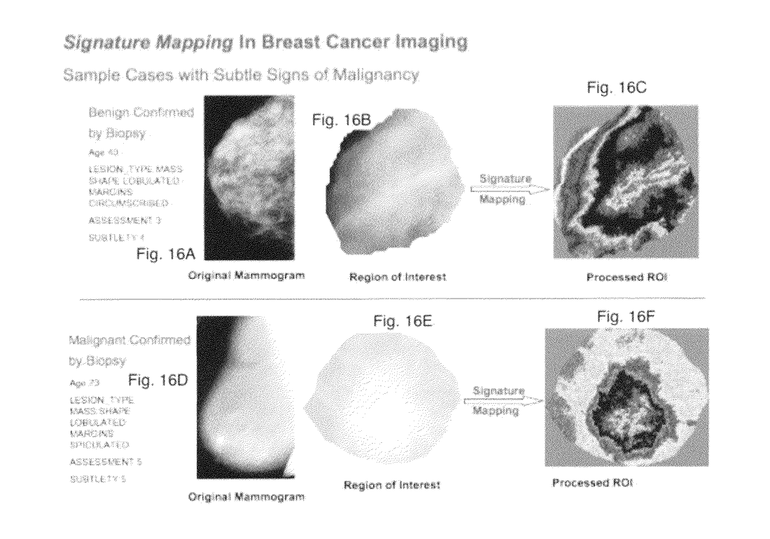

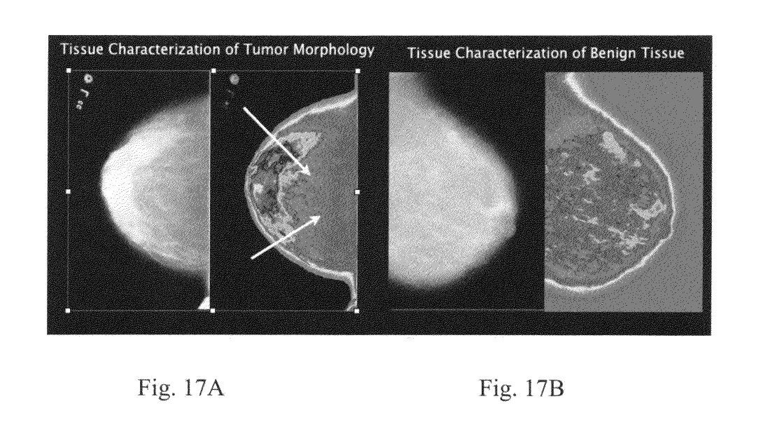

FIGS. 16A-16F show additional results of the process using mammography images with subtle signs of growths. FIGS. 16A-16C are with a subtle benign growth, and FIGS. 16D-16F are with a subtle malignant growth. FIGS. 16C and 16F show the result of processing each image with the process described above.

Cancerous lesions grow at the expense of normal tissue. This cell growth not only consumes the normal tissue but also distorts the normal tissue surrounding the lesion. Patterns of distortion correlated with cancer or other disease growth in tissues can be revealed, quantified and classified using the Signature Mapping/ITD process. This provides a highly-correlated set of features for the positive identification of the presence of cancer in a patient.

In FIGS. 17A and 17B, the mammogram on the left indicates the presence of cancer. Two white arrows in the processed image to its right show the distortions generated from compression of the normal breast tissue. This distortion is not visible in the original image on the left. The two images in FIG. 17B show an x-ray of a normal breast and there is no distortions indicated in the processed image on the far right.

The Signature Mapping/ITD process can be applied to all imaging modalities, such as sonograms from ultrasound imagers, and then the features from each of the modalities can be combined to obtain an even higher levels of sensitivity for the detection of the disease.

The following is one example of a possible sequence of a Signature Mapping/ITD process that can be applied to a sonogram of breast tissue:

(1) Convert the original grayscale x-ray image into a color space such as RGB;

(2) Normalize the image;

(3) Apply a series of non-linear transformations to segment and differentiate a cancerous from benign lesion;

(4) Quantify the color values of the lesions;

(5) Convert the image back into grayscale for display;

(6) Quantify the luminance values of the lesions; and

(7) Classify the objects.

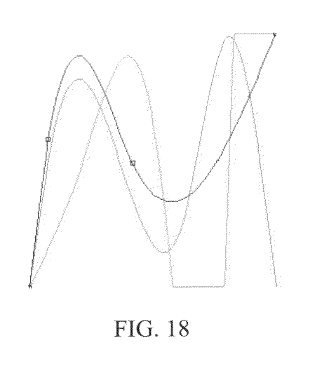

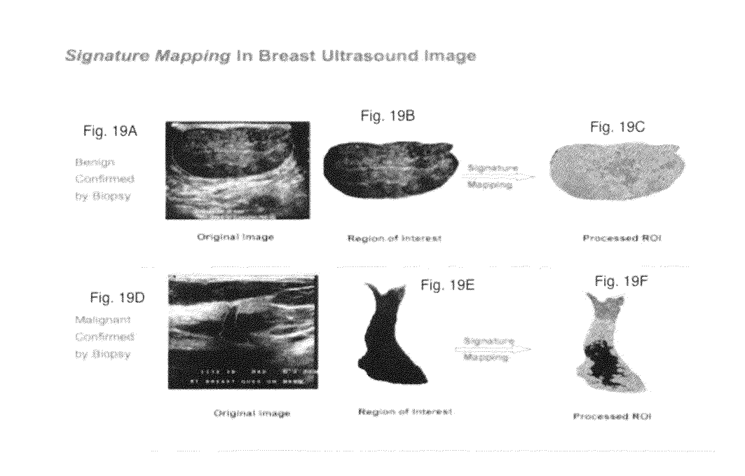

In the above example, a single transform is applied to the image or objects segmented from the image. One example of a transform that can be used is shown in FIG. 18. The x values along the bottom are luminance input values, and the y axis represents luminance output values. The color image is analyzed then converted back to grayscale from the color space for additional analysis.

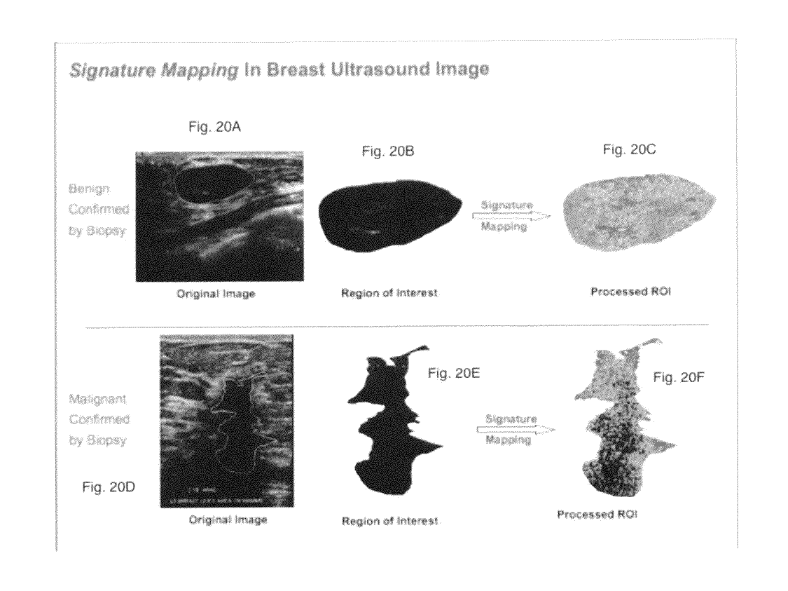

Visualization results of ultrasound processing can be seen in FIGS. 19A-19F and FIGS. 20A-20F. Like the images before, FIGS. 19A, 19D, 20A and 20D are the original images, FIGS. 19B, 19E, 20B and 20E are the regions of interest and FIGS. 19C, 19F, 20C and 20F are the processed images. Significant differences can be observed between the benign and malignant processed images, even though the differences between the original images are difficult to distinguish. Similar results to those described above for ultrasound images can be obtained by applying this methodology to breast MRIs.

Analysis of the most effective features from mammography and ultrasound, which were used to create SVM Detection Model, shows that a specific processed image of carcinoma tissue was well detected by the Model. The best features led to the detection of specific texture which reflects the growing structures of a Carcinoma. It showed through a high presence of oriented clouds of pixel blobs which reflected the abnormal cells growing in a specific direction.

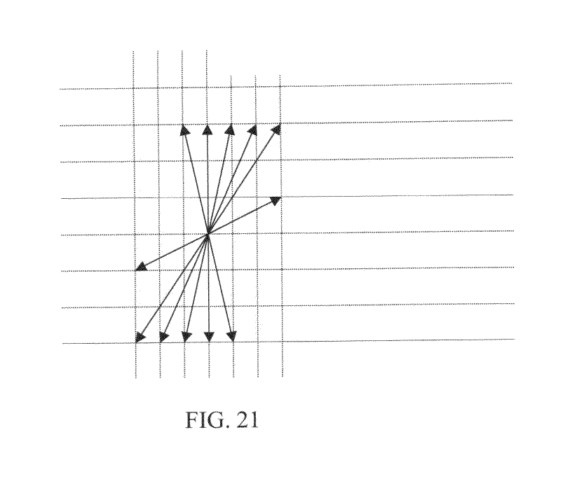

FIG. 21 is a vector representation that reflects the vertical and non-vertical directions of growth found in cancerous lesions. Benign lesions do not exhibit such growth patterns.

The growth patterns characterized in the Signature Mapping processes is highly specific for each type of tissue regardless of imaging modality and consequently, its characteristic responses (signatures) can be correlated across multiple modalities (e.g., x-ray, ultrasound, MRI, etc.). This makes it possible to calculate and provide a higher quantifiable “level of confidence” to help make better medical diagnostic decisions.

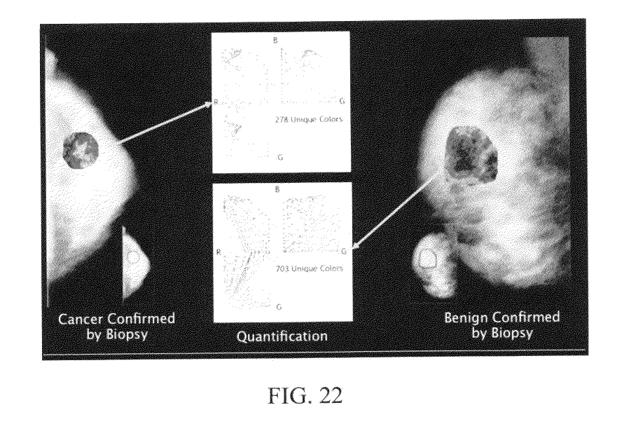

Cancerous lesions also show differences in the number of colors and the distribution of those colors compared with benign lesions as shown in FIG. 22.

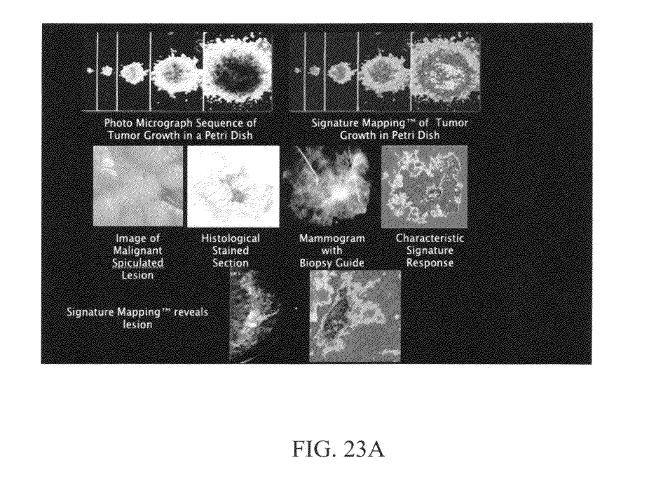

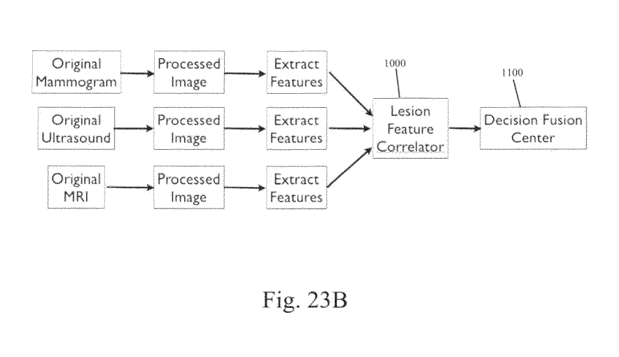

In the FIG. 23, patterns of cancerous lesions can be compared among growth of cancer in a culture in a petri dish (top row of images), patterns of cancer in an image taken from a biopsy under a microscope (two left images in the middle row), and the patterns of cancer in a mammogram (two right images in middle row and bottom row of images). In all cases, the responses to the Signature Mapping/ITD algorithms indicate the similar structures for the cancer.

Because of the characteristics of Signature Mapping and its ability to characterize tissue types for both visualization and digital classification, a Multi-Modality Computer Aided Diagnosis (MM-CADx) system now becomes possible. The configuration of the MM-CADx system consists of Region of Interest (ROI) Analysis to automatically generate features (e.g., texture, shape, size, etc.) of breast tumors or masses and three ROI Classification modules to automatically generate diagnosis of tumors (benign vs. malignant) by integrating results from mammograms, sonograms, and MRI images for the same patient. The MM-CADx system also consists of a Lesion Feature Correlator and a Decision Fusion Center to generate correlated features and optimal diagnosis from different modalities, respectively, to allow radiologists to make more accurate and faster diagnosis. A Feature Matching and Image Retrieval module of MM-CADx system allows users to retrieve similar tumors from the reference library to examine the optimal features, and review the diagnosis results to make a final diagnosis.

In the example shown in FIG. 23B, original digital images from three imaging modalities, x-ray (mammograms), ultrasound and MRIs, are processed by the Signature Mapping/ITD process using methods that have been described above. Images from each modality are processed with different Signature Mapping/ITD processes, where each process is optimized to differentiate tissues of interest based on the spatial and frequency characteristics for that modality. Features are then extracted from the processed images/regions of interest from each modality and combined for analysis in the Lesion Feature Correlator 1000. While co-occurrence features might represent the highest probability of correctly classifying a lesion in a sonogram, color characteristics might be more relevant in a mammogram. The relevant features from all modalities, and possibly their related probability density functions, are then combined and analyzed in the Decision Fusion Center 1100 using classifiers, such as Support Vector Machines, decision trees or neural networks.

B. Machine Learning Algorithms (MLA) Used for Image Classification

As discussed above, MLAs are responsible for generating the detection system that determines if an object of interest is present. Using Machine Learning Algorithms for image classification is herein referred to as “contextual imagery.” Contextual imagery not only focuses on the segmented imaged, but on the entire image as well. Context often carries relevant and discriminative information that could determine if an object of interest is present or not in the scene.

MLAs analyze the vectors of metrics taken from the images. The choice of metrics is important. Therefore, the feature extraction process preferably includes “data conditioning” to statistically improve the dataset analyzed by the MLA.

Image conditioning is preferably carried out as part of the data conditioning. Image conditioning is one of the first steps performed by the image processing function. It initially consists of the removal of obvious or almost obvious objects that are not one of the objects of interest from the image. By applying image processing functions to the image, some important observations can also be made. For example, some unobvious portions of the object of interest may be distinguished from other elements that are not part of the object of interest upon the application of certain types of image processing. These aspects of image conditioning leverage the MLA's detection capability

Image normalization is preferably the first process applied to the image. This consists of the removal of certain image characteristics, such as the artificial image enhancement (artifacts) that is sometimes applied the system that created the image. Image normalization could also include removing image distortions created by the acquisition system, as well as removal of intentional and unintentional artifacts created by the software that constructed the image.

There are thousands of Machine Learning Algorithms including, but not limited to, Kernel Systems such as the Support Vector Machines (SVMs) that are preferably used as one of the classification instruments. The SVM approach exhibits the following advantages:

1. It can be used with data that has a complicated structure for which a simple separating hyperplane is not sufficient for classification purposes. A nonlinear separating surface between the classes can be drawn with the SVM technique.

2. The separating surface is drawn by the SVM technique in an optimal way, maximizing the margin between the classes. In general, this provides a high probability that, with proper implementation, no other separating surface will provide better generalization performance within this framework.

3. Even when the amount of available data is small, the generalization performance is impressive.

4. The SVM technique is robust to small perturbations and noise in data.

5. A positive synergetic effect is often possible. This means that adding image data collected from new objects of interest (e.g., new types of explosives) frequently results in a more efficient recognition of images of objects of interest already included in the model.

In the case of a data set in which different classes are not linearly separated in the feature space, it is necessary to design a nonlinear separating rule between them. However, this rule can be developed in an infinite number of ways. For example, using a method of potential functions, it is possible to reach 100% of the class separation for the training data set. At the same time, the respective model would typically have a very poor generalization performance on the unseen data. This effect is commonly called ‘overfitting’. Thus, the goal is to avoid over-fitting while using the nonlinear approach.

To address this issue, the SVM technique relies on the following stages:

(1) mapping the initial feature vectors to a new feature space using a nonlinear transformation; and

(2) applying a linear separating rule (a hyperplane) to vectors in the new feature space.

The use of these two stages allows one to draw the nonlinear separating surface in the original feature space. The linear character of the separating rule means, in general, better robustness and the possibility of maximizing the margin between the classes explicitly.

An improved immunity to both noise and presence of possible outliers is provided by introducing a “soft” margin. When a soft margin is used, a predetermined portion of training vectors are allowed to be misclassified. Negative consequences of the over-fitting effect can be significantly diminished or even completely averted by sacrificing this small portion of typically non-representative vectors. As a result, a much better overall. generalizing performance and robustness can be achieved in practical applications.

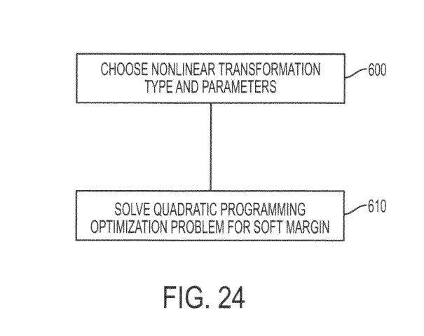

FIG. 24 is a flowchart of a method of creating an SVM model, in accordance with one embodiment of the present invention. The method starts at step 600, where a nonlinear transformation type and its parameters are chosen. The transformation is performed by the use of specific “kernels”, which are mathematical functions. Sigmoid, Gaussian or Polynomial kernels are preferably used.

Then, at step 610, a quadratic programming optimization problem for the soft margin is solved efficiently. This requires a proper choice of the optimization procedure parameters as well.

During the quadratic programming optimization procedure, some of the most representative vectors are selected from the pool of all vectors available for training. These vectors are herein referred to as “Support Vectors.” The respective weights of the Support Vectors and a free term (a constant) are also calculated. This completes the SVM model.

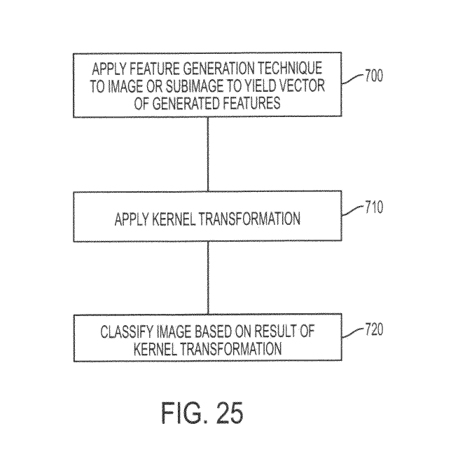

FIG. 25 is a flowchart of a method of performing an SVM operation, in accordance with one embodiment of the present invention. When a previously unseen image is classified (any sub-image can also be used instead of the image), a feature generation technique is applied at step 700 to yield a vector of the generated features that is used for the analysis.

At step 710, a specified kernel transformation is applied to each of all possible couples of the analyzed vector and a Support Vector. The received values are weighted according to the respective weight coefficients and added all together with the free term.

At step 720, the result of the kernel transformation is used to classify the image. In a preferred embodiment, the image is classified as falling in a first class (e.g., a threat) if the final result is larger than or equal to zero, and is otherwise classified as belonging to a second class (e.g., non-threat).

Although this framework was described in connection with two possible classes, it can be applied to multi-class classification problems with appropriate modification of the framework.

C. RGB-DNA Image Analysis

As discussed above, RGB-DNA is one of the image processing techniques that can be used in normalization step 400 and the image processing step 410 (FIG. 8). The phrase “RGB-DNA”, as used herein, refers to a representation, in a predetermined color space, of most or all possible values of colors which can be produced from a given image source. The phrase “values of colors” is not limited to visual colors, but refers to representations of values, energies, etc. that can be produced by the imaging system. The use of RGB DNA for image analysis will be described in detail in this section.

### Mathematics of Dual Energy Technique Without Colors

The two integral equations (1) and (2) below describe the flux of X-ray photons F_{L}(θ) and F_{H}(θ) measured by low energy and high energy detectors, respectively, for the geometry shown in FIG. 20.

$$\begin{matrix}{\int }_{{E}_{min}}^{{E}_{max}} \frac{{r}_{0}^{2}}{{r}_{L}^{2} ( θ )} \times S ( θ , {r}_{0} , E ) \times exp [ - \frac{P}{{E}^{3}} - {f}_{KN} ( E ) \times C ] d E = {F}_{L} ( θ ) & ( 1 ) \\ {\int }_{{E}_{min}}^{{E}_{max}} \frac{{r}_{0}^{2}}{{r}_{H}^{2} ( θ )} \times S ( θ , {r}_{0} , E ) \times exp [ - \frac{P}{{E}^{3}} - {f}_{KN} ( E ) \times C ] \times Q ( θ , E ) \times d E = {F}_{H} ( θ ) & ( 2 )\end{matrix}$$

where function

$${\int }_{{r}_{0}}^{P ( θ ) = {r}_{L} ( θ )} {k}_{p} \frac{ρ ( r , θ )}{A ( r , θ )} {Z}^{n} ( r , θ ) \times d r \qquad ( 3 )$$

is a photoelectric term or fraction of attenuation, and function

$${\int }_{{r}_{0}}^{C ( θ ) = {r}_{L} ( θ )} {k}_{c} \frac{ρ ( r , θ )}{A ( r , θ )} Z ( r , θ ) \times d r \qquad ( 4 )$$

is the Compton term of attenuation considered for every fixed value of polar angle θ. P(θ) and C(θ) are the desired solution we are looking for. The function of the energy selective (copper) filter is defined as

$$Q ( θ , E ) = exp [ - {\int }_{{r}_{L} ( θ )}^{{r}_{H} ( θ )} {μ}_{f} ( θ , r , E ) \times d r ] \qquad ( 5 )$$

The other symbols and definitions used in Equations (1) and (2) are as follows:

S(θ,r₀,E)—the input flux of x-ray photons of energy E at the surface with radius r₀;

r₀—the distance from the x-ray generator spot to the surface where S is known;

r_{L}—the distance to the low energy detector;

r_{H}—the distance to the high energy detectors (r_{L}−r_{L} is the thickness of the filter);

θ—polar angle

Z=Z_{eff}—the effective atomic number

ƒ_{KN}(E)—Klein-Nishina function of Compton attenuation energy dependence;

ρ—physical mass density;

A—atomic weight;

ρ/A—density of atoms;

kₚ and k_{c} are the constants dependent on the system of units of measurements; and

n—empiric parameter (n=4 for our case).

For any given angle θ, the unknown variables are P, which is responsible for photoelectric, and C, which stands for Compton attenuation. This nonlinear system can be solved when Jacobian

$$J = det ( \begin{matrix}\partial {F}_{L} / \partial P & \partial {F}_{L} / \partial C \\ \partial {F}_{H} / \partial P & \partial {F}_{H} / \partial C\end{matrix} \neq 0 \qquad ( 6 )$$

If P and C are found for a particular case of a uniform layer of thickness L with ρ=const, Z=const, A=const, it means that:

$$\begin{matrix}P ( x , y ) = {k}_{p} \frac{ρ}{A} {Z}^{n} \times L = {k}_{p} d \times {Z}^{n} & ( 7 ) \\ C ( x , y ) = {k}_{c} \frac{ρ}{A} Z \times L = {k}_{c} d \times Z & ( 8 )\end{matrix}$$

where

$$d = \frac{ρ}{A} \times L \qquad ( 9 )$$

is the integral density, and ratio

$$\frac{P}{C} = \frac{{k}_{p}}{{k}_{c}} {Z}^{n - 1} \qquad ( 10 )$$

does not depend on d. Therefore,

$$\begin{matrix}Z = ( \frac{P}{C} \frac{{k}_{c}}{{k}_{p}} {1 / ( n - 1 )}^{} & ( 11 ) \\ d = P / ( {k}_{p} \times {Z}^{n} ) = C / ( {k}_{c} \times Z ) = C / [ {k}_{c} \times ( \frac{P}{C} \frac{{k}_{c}}{{k}_{p}} {1 / ( n - 1 )}^{} ] & ( 12 )\end{matrix}$$

It can be seen that Z=const if the ratio P/C'const. In the (P,C) space, Z=const forms a straight line which goes from the point of origin, and the tangent of the angle between the line and P axes is equals to C/P. The plot shown in FIG. 21 shows the lines in conditional units.

The surface Z=Z(P,C) is two-dimensional manifold in three-dimensional (P,C,Z) space, as shown in the plot of FIG. 22. The surface d=d(P,C) is a two-dimensional manifold in (P,C,d) as well, a shown in the plots of FIGS. 23A and 23B, which are plots of 2D and 3D views, respectively, of (P,C) space with Zeff(P,C)=const.

The result derived above shows the straight and simple interpretation of the lines and points in the (P,C) space. Each point with coordinates P and C in the space can be computed from the equations (1) and (2) if the right parts are measured correctly and Jacobian is nonzero. Each of the points reflects the effective atomic number Z and integral density d of an object responsible for the measured right parts of the system.

### Colors in Dual Energy Scanners Without Mathematics

Any color image we see on the computer screen of a dual energy scanner is a 2D array of pixels with colors represented by (R,G,B) triplets. Each of these three values (R,G,B) belongs to the interval [0,255], and the (R,G,B) set of all possible colors composes the 3D RGB space or cube of 256³=16777216 discrete points. One can thus assume that the number of unique colors needed to maintain an acceptable visual quality of a dual energy color image can be quite large and approaches at least the number of colors of a medium class digital camera ˜1500000. Nevertheless, it was discovered that the number of unique colors in an average baggage color image is approximately 7,000 colors for a Smith HiScan 6040i baggage scanner and less than 100,000 for a Rapiscan 515 baggage scanner.

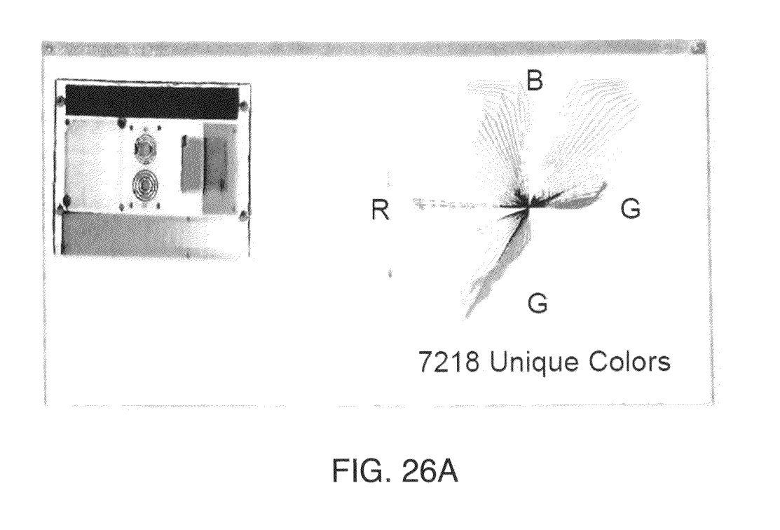

An aspect of the present invention is the development of tools to visualize the set of unique colors as 3×2D projections to RG, GB and BR planes of the RGB cube, as shown in FIG. 26A. FIG. 26A is an RGB_DNA 3×2D view for a Smith HiScan 6040i baggage scanner. The phrase “RGB_DN was assigned to the discovered color schemes, where term “DNA” was used because of the fact that all images, at least from the scanners of a particular model, will inherit this unique set of RGB colors. These tools can also be applied to medical imagers, such as medical x-ray imagers, ultrasound imagers and MRI imagers.

The image analysis system 130 can be implemented with a general purpose computer. However, it can also be implemented with a special purpose computer, programmed microprocessor or microcontroller and peripheral integrated circuit elements, ASICs or other integrated circuits, hardwired electronic or logic circuits such as discrete element circuits, programmable logic devices such as FPGA, PLD, PLA or PAL-or the like. In general, any device on which a finite state machine capable of executing code for implementing the process steps of FIG. 7 can be used to implement the image analysis system 130.

Input channel 110 may be, include or interface to any one or more of, for instance, the Internet, an intranet, a PAN (Personal Area Network), a LAN (Local Area Network), a WAN (Wide Area Network) or a MAN (Metropolitan Area Network), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34bis analog modem connection, a cable modem, and ATM (Asynchronous Transfer Mode) connection, or an FDDI (Fiber Distributed Data Interface) or CDDI (Copper Distributed Data Interface) connection. Input channel 110 may furthermore be, include or interface to any one or more of a WAP (Wireless Application Protocol) link, a GPRS (General Packet Radio Service) link, a GSM (Global System for Mobile Communication) link, CDMA (Code Division Multiple Access) or TDMA (Time Division Multiple Access) link such as a cellular phone channel, a GPS (Global Positioning System) link, CDPD (Cellular Digital Packet Data), a RIM (Research in Motion, Limited) duplex paging type device, a Bluetooth radio link, or an IEEE 802.11-based radio frequency link. Input channel 110 may yet further be, include or interface to any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection.

The foregoing embodiments and advantages are merely exemplary, and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. Various changes may be made without departing from the spirit and scope of the present invention, as defined in the following claims.

What is claimed is:

1. A method of identifying a malignant region in a medical image, comprising:
receiving a medical image;
applying at least one non-linear transformation to the medical image to segment and differentiate regions of interest; and
determining whether a region of interest represents a malignant region or a benign region.

2. The method of claim 1, wherein the medical image is a mammogram.

3. The method of claim 1, wherein the medical image is a an ultrasound image.

4. The method of claim 1, wherein the medical image is an MM.

5. The method of claim 1, wherein the medical image is normalized prior to applying the at least one non-linear transform.

6. The method of claim 1, wherein the medical image comprises a grayscale image.

7. The method of claim 6, wherein further comprising converting the grayscale image into a color space prior to applying the at least one non-linear transform.

8. The method of claim 7, wherein the determining step comprises:
quantifying color values of the regions of interest;
converting the image back to a grayscale image for display; and
classifying the regions of interest.
